(19) United States
(12) Patent Application Publication
(10) Pub. No.: US 2009/0195918 A1
(43) Pub. Date: Aug. 6, 2009

(54) METHOD AND APPARATUS FOR REPRODUCING INFORMATION ON BIT-PATTERNED RECORDING MEDIUM

(76) Inventor: Nobuhide AOYAMA, Kawasaki (JP)

Correspondence Address: STAAS & HALSEY LLP, SUITE 700, 1201 NEW YORK AVENUE, N.W., WASHINGTON, DC, 20005, US

(21) Appl. No.: 12/363,181

(22) Filed: Jan. 30, 2009

(30) Foreign Application Priority Data
Feb. 4, 2008 (JP) 2008-23488

(51) Int. Cl. G11B 5/596

(52) U.S. Cl. 360/77.08; G9B/5.216

(57) ABSTRACT

The information reproducing method manages an average magnetization state of each sector on a bit-patterned recording medium as sector management information and sets an information reproduction condition for the sector on the bit-patterned recording medium, based on the sector management information.

### CROSS-REFERENCE TO RELATED APPLICATIONS

This application is based upon and claims the benefit of priority from the prior Japanese Patent Application No. 2008-23488 filed on Feb. 4, 2008, the entire contents of which are incorporated herein by reference.

### BACKGROUND

1. Field of the Invention

The present application describes techniques for stably reproducing information on a bit-patterned recording medium that use a recording layer in which magnetic substances are discontinuously formed according to recording bits of information.

2. Description of the Related Art

As shown generally in FIG. 16, a hard disk records and reproduces information on a disc-like recording medium 1603. The disc-like recording medium 1603 is driven by a spindle motor 1602 installed in a base 1601, by means of a magnetic head 1606 installed at the tip of a suspension 1605. The magnetic head 1606 is driven by a voice coil motor 1604 installed in the base 1601.

The recording capacity of a hard disk approximately doubles annually. In recent years, the recording density has been further improved by a vertical magnetic recording scheme, such as that shown in FIG. 17. In this scheme, magnetic recording is performed as follows: a recording medium includes a soft magnetic under layer 1701 and a magnetic layer 1702 and rotationally moves in a medium traveling direction 1708. Magnetic recording is performed on the magnetic layer 1702 in a direction vertical to a surface of the recording medium by a recording magnetic field 1707 generated by a magnetic head having a main magnetic pole 1703, a return yoke 1704, and a coil 1705. Upon reproduction, this magnetic recoding state is read by a reproduction element 1706 and an information signal is reproduced.

Furthermore, attention is given to a BPR (Bit-Patterned Recording) scheme as a future candidate for high-density magnetic recoding. The BPR scheme during uses a recording layer in which, as shown in FIG. 18, magnetic substances are discontinuously formed as bit patterns 1801 according to recording bits of information, instead of a conventional two-dimensionally continuous recording layer.

Since a BPR medium is fabricated by transferring bit patterns formed on a master, media having the same bit patterns can be produced in large quantity. By using this feature, as shown in FIG. 19, and by recording information using the shapes and arrangements of bit patterns 1901, the medium can be used as a BPR-ROM (Bit-Patterned Recording Read Only Memory).

In recent years, the capacities of OSes (Operating Systems), software, moving image content, etc., have increased to approximately several tens of gigabytes. Particularly for moving images, due to the proliferation of high-vision televisions, etc., saving of high-quality images is required, and thus, a required recording capacity has increased. However, a large number of media are required to distribute such content via CD-ROM or DVD. In such a situation, use of the BPR-ROM medium is the optimum choice for content distribution because bit patterns can be easily replicated.

However, since the BPR-ROM has fixed patterns, there are problems of asymmetry of a reproduction waveform and crosstalk from an adjacent track.

First, asymmetry will be described. When different patterns, specifically, patterns with different recording bit lengths, are reproduced during reproduction of a BPR medium, as shown as 2001 and 2002 in FIG. 20A, signals having different output amplitudes appear. In this case, when output center values calculated from the respective output amplitudes substantially match each other, as shown as 2003 in FIG. 20A, such a reproduction waveform can be said to have small asymmetry. On the other hand, when the output center values mismatch each other, as shown as 2004 and 2005 in FIG. 20B, such a reproduction waveform can be said to have large asymmetry.

Crosstalk is a phenomenon in which when an adjacent track is considerably offset and approaches a reproduction track, a signal from the adjacent track leaks into the reproduction track, and is observed as a crosstalk waveform, such as that shown as 2101 in FIG. 21.

In a waveform with large asymmetry as described above, it is difficult to set threshold values (e.g., 2003, 2004, and 2005 in FIGS. 20A and 20B) for determining bit values of information in a reproduction waveform, and thus, there is a problem that a signal error occurs. This asymmetry is a phenomenon caused by the shapes of bit patterns, the asymmetry of a reproduction element, the nonlinearity of a detection circuit, etc. When a normal continuous magnetic recording layer is used, this phenomenon can be improved by adjusting an information recording condition, specifically, by allowing a current waveform flowing through a recording head to have asymmetry in an opposite direction to that of the aforementioned reproduction characteristics and then performing re-recoding.

Crosstalk can be improved by adding a track offset in a direction in which the aforementioned crosstalk of a reproduction signal is reduced when information is recorded, and then re-recording the information.

In the case of a so-called rewritable BPR medium, for an information sector where error has occurred due to the aforementioned asymmetry or crosstalk, an alternate sector is prepared and information is recorded in the alternate sector, whereby the problem can be avoided.

However, in a BPR-ROM, since information is detected from patterns that are fixedly recorded in advance in a factory, there is a problem of difficulty in improving reproduction characteristics by rewriting information, and in performing additional recording into an alternate sector, such as those described above.

### SUMMARY

in one aspect, asymmetry caused by fixed bit patterns and crosstalk from an adjacent track in a BPR-ROM that uses a bit-patterned recording medium is improved.

According to one of an embodiment, an information reproducing method manages an average magnetization state of each sector on a bit-patterned recording medium as sector management information and sets an information reproduction condition for the sector on the bit-patterned recording medium, based on the sector management information.

The above-described embodiments of the present invention are intended as examples, and all embodiments of the present invention are not limited to including the features described above.

### BRIEF DESCRIPTION OF THE DRAWINGS

FIG. 1 is a cross-sectional view of a BPR medium;

FIG. 2 is a flowchart showing a BPR medium fabrication process;

FIG. 3 is a diagram showing a configuration showing a relationship between a BPR reproduction head and a BPR-ROM medium;

FIG. 4 is a diagram showing a configuration of an embodiment of an information reproducing apparatus of the present invention;

FIG. 5 is a flowchart of a process of obtaining and setting sector management information;

FIG. 6 is a diagram showing a configuration of a sector management table;

FIG. 7 is a diagram (part 1) showing an exemplary polarity arrangement on the BPR-ROM medium;

FIG. 8 is a diagram (part 2) showing an exemplary polarity arrangement on the BPR-ROM medium;

FIG. 9 is a diagram (part 3) showing an exemplary polarity arrangement on the BPR-ROM medium;

FIG. 10 is a diagram showing a configuration of a sector management table including adjacent sector information;

FIG. 11 is a diagram showing an influence exerted on a reproduction track by the magnetization state of an adjacent track;

FIG. 12 is diagram showing a signal waveform in a polarity reversing unit;

FIG. 13 is a diagram showing a configuration of a BPR-ROM medium having a buffer area;

FIG. 14 is a diagram showing a configuration of reproduction processing systems that perform buffer area control;

FIG. 15 is a diagram showing operation timing of the reproduction processing systems that perform buffer area control;

FIG. 16 is a generic schematic diagram of a hard disk;

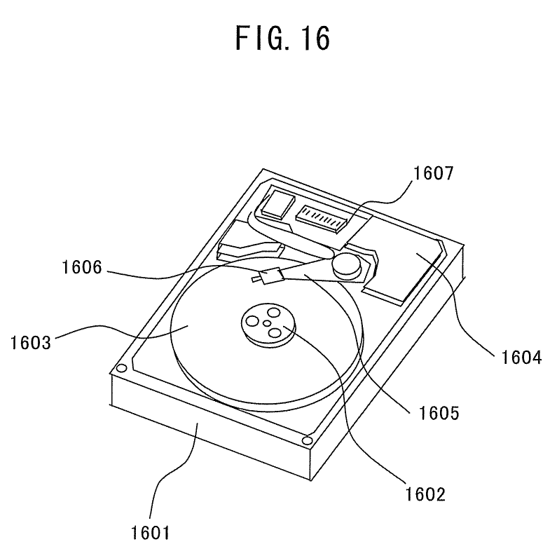

FIG. 17 is a schematic diagram showing a vertical magnetic recording scheme;

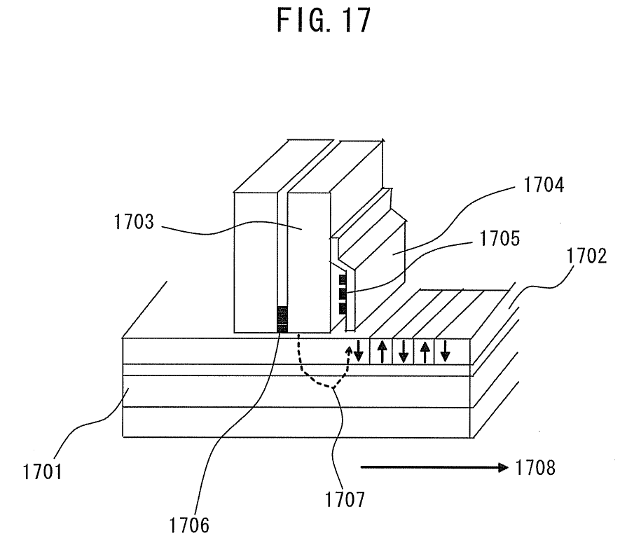

FIG. 18 is a schematic diagram showing a BPR scheme;

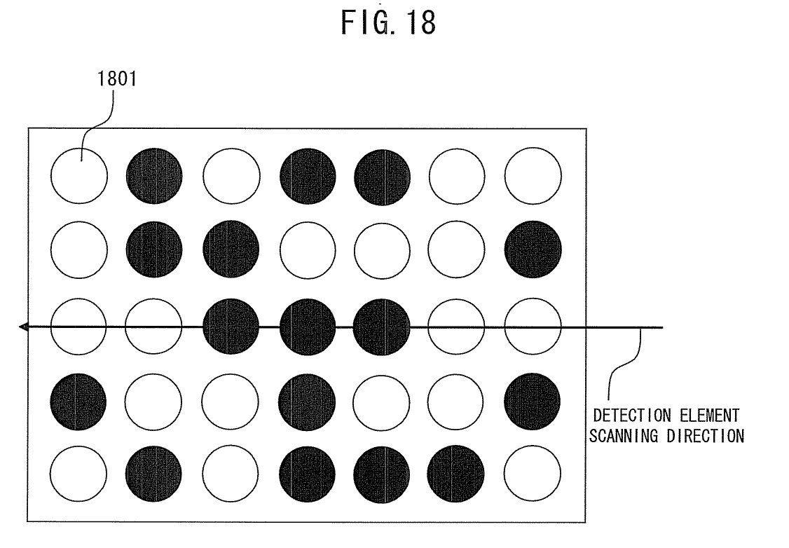

FIG. 19 is a schematic diagram of a BPR-ROM;

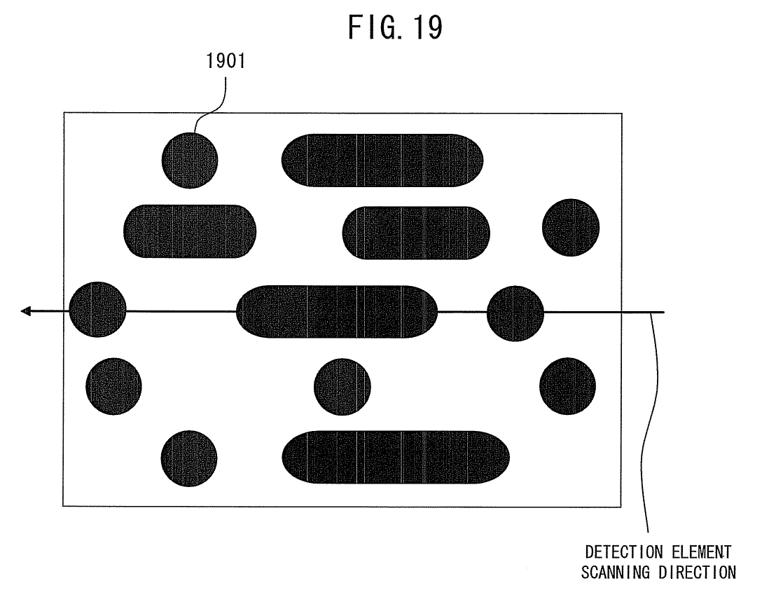

FIGS. 20A and 20B are diagrams describing asymmetry of reproduction waveforms; and

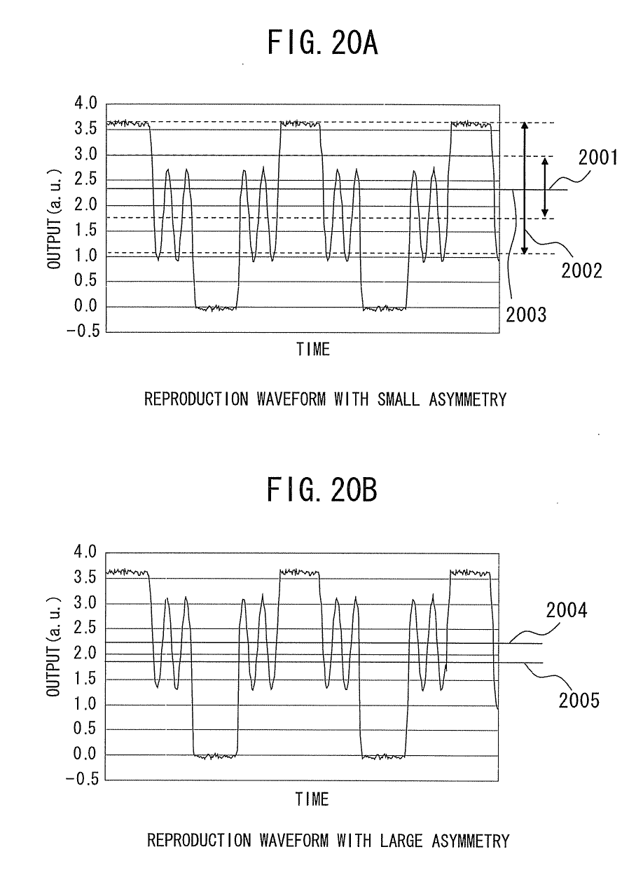

FIG. 21 is a diagram describing crosstalk in a reproduction waveform.

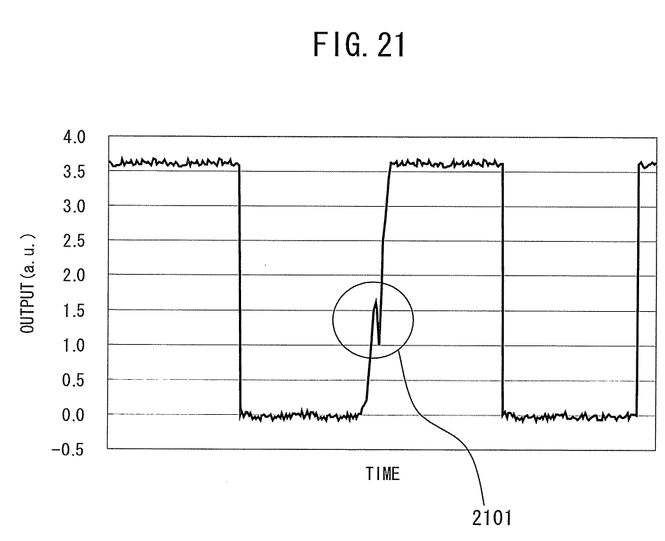

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

The best mode of the present invention will be described in detail below with reference to the drawings.

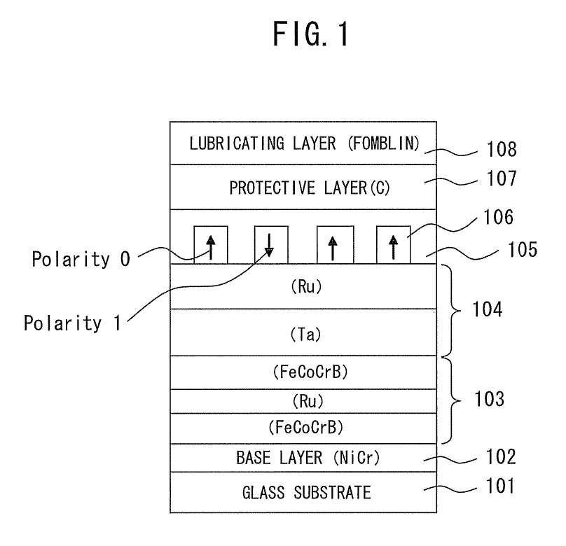

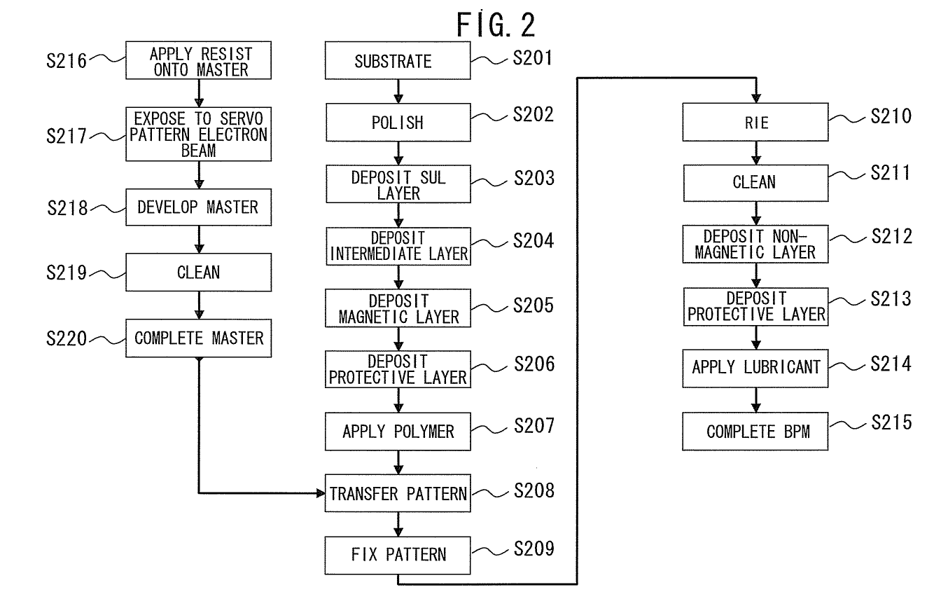

FIG. 1 is a cross-sectional configuration diagram of a BPR-ROM medium in an embodiment of the present invention. FIG. 2 is a flowchart showing a BPR-ROM medium fabrication process. In the following, reference numerals 101 to 108 respectively correspond to reference numerals in FIG. 1 and reference numerals S201 to S220 respectively correspond to reference numerals in FIG. 2.

A NiCr alloy layer is formed on a substrate 101 as a base layer 102 (S201 and S202) after the glass substrate 101 is polished. Any Material other than a NiCr alloy can be used for the base layer as long as the material is a metal that enhances film adhesion and has corrosion resistance.

A soft magnetic under layer (SUL) 103 is deposited on the base layer 102. A Ru alloy layer with a subnanometer thickness is inserted between FeCoCrB alloy layers of the soft magnetic underlayer 103. Magnetizations of the upper and lower FeCoCrB alloy layers are antiparallelly coupled through the Ru alloy layer (S203).

A Ta alloy layer and a Ru alloy layer are deposited on the soft magnetic under layer 103 as an intermediate layer 104 (S204).

A vertical magnetic recording layer 106 is deposited on the intermediate layer 104 (S205). The vertical magnetic recording layer 106 uses a CoCrPt alloy. An artificial lattice film having formed therein multiple Co/Pt thin films can be used for the vertical magnetic recording layer 106 with no problem.

A carbon (C) layer is deposited on the vertical magnetic recording layer 106 as a protective layer 107 (S206).

A deposition medium is produced in the above-described manner.

Meanwhile, independently of the above-described process, a master is fabricated by processes of resist application (S216), servo pattern electron beam exposure (S217), development (S218), cleaning (S219), and completion (S220).

Patterns of the master thus fabricated are transferred (S208) and fixed (S209) onto the deposition medium. The deposition medium is further subjected to a polymer application process (S207) after being fabricated at the aforementioned S201 to S206.

Subsequently, in the deposition medium having bit patterns transferred thereonto, bit patterns are formed in the vertical magnetic recording layer 106 by a Reactive Ion Etching (RIE) method.

Thereafter, cleaning is performed to remove residual polymer, etc. (S211). A non-magnetic layer 105 of an alloy with high corrosion resistance, such as a Ta alloy, is deposited to cover the bit patterns of the vertical magnetic recording layer 106 (S212). A protective layer 107 (S213) and a lubricating layer 108 (S214) are sequentially deposited on the non-magnetic layer 105, whereby a bit-patterned medium (BPM) is completed (S215).

Next, an embodiment of the present invention will be described that relates to an information recording and reproducing apparatus using a BPR-ROM medium fabricated in the above-described manner.

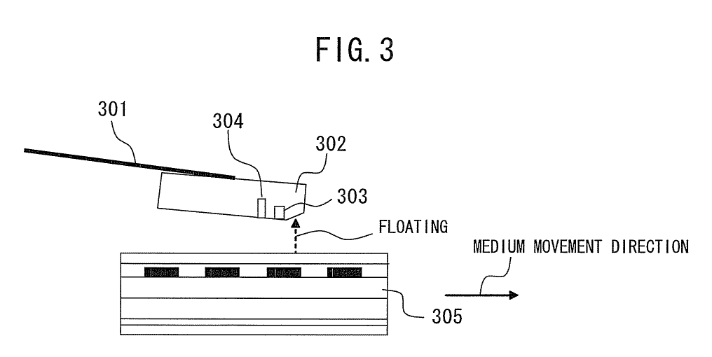

First, FIG. 3 is a configuration diagram showing a relationship between a BPR reproduction head and a BPR-ROM medium. As shown in FIG. 3, reproduction of information and obtaining of management information on a sector-by-sector basis according to the present invention are performed with a portion that includes a magnetic head and a suspension 301 floating over a BPR-ROM medium 305 fabricated in the above-described manner. The magnetic head has a magnetic field application element 303 and a reproduction element 304 that are attached to a slider 302. The suspension 301 supports the magnetic head.

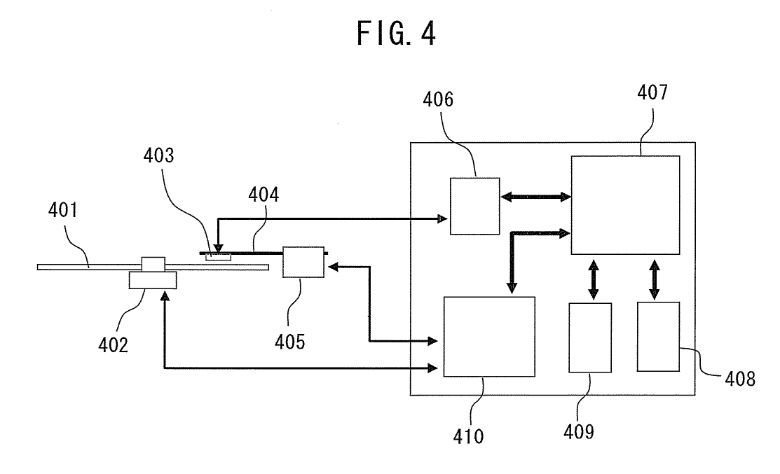

FIG. 4 is a configuration diagram of an embodiment of an information reproducing apparatus of the present invention that has the configuration shown in FIG. 3.

A BPR-ROM medium 401 (which is the same as 305 in FIG. 3) is rotated by a spindle motor 402 at a predetermined number of revolutions.

A magnetic head 403 and a suspension 404 supporting the magnetic head 403 can access a predetermined medium radius location by a voice coil motor 405.

The BPR-ROM medium 401 has servo patterns formed thereon in advance (see S217 in FIG. 2). Tracking to a predetermined track is performed based on a servo signal detected by the magnetic head 403.

The rotation of the BPR-ROM medium 401 and access to a predetermined track and sector are performed by a servo controller 410 controlling the spindle motor 402, the voice coil motor 405, the suspension 404, and the magnetic head 403 under monitoring by a main controller unit 407.

An information signal read from the BPR-ROM medium 401 by the magnetic head 403 is inputted to the main controller unit 407 through a preamplifier 406.

A data buffer memory 408 temporarily records a reproduced information signal and, for example, DMA transfers the signal to an external device, if necessary.

A flash memory 409 records sector management information according to the present invention. The sector management information is read, when information is reproduced, from the flash memory 409 to the main controller unit 407, as control information.

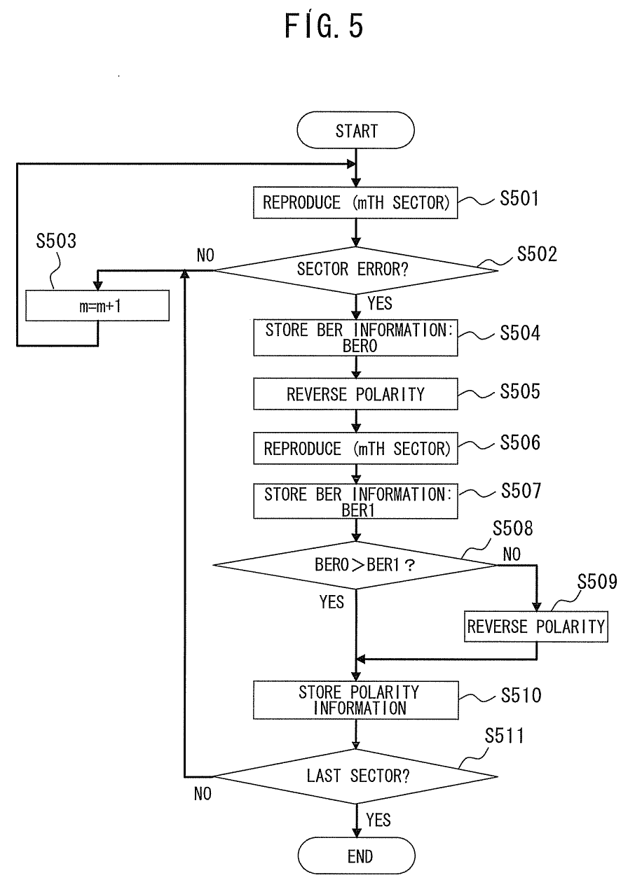

FIG. 5 is an operation flowchart showing a process of obtaining and setting sector management information according to the present invention. The operation is implemented as an operation performed by the main controller unit 407 to control each unit in FIG. 4 while executing a program contained in the main controller unit 407.

First, a desired sector (an mth sector) on the BPR-ROM medium 401 is accessed to perform reproduction of information (S501). Then, it is determined whether a sector error has occurred (S502).

If a sector error has not occurred, i.e., the determination at operation S502 is NO, then the sector number m is incremented by one (S503) and a next sector is accessed (S503->S501).

If an error has occurred in the mth sector, i.e., the determination at operation S502 is YES, then a byte error rate (BER) is obtained as a reproduction characteristic parameter and a value obtained by DA (digital analog) converting the BER is held as BER0 in, for example, a register (not shown) included in the main controller unit 407 (S504).

Thereafter, the main controller unit 407 waits for the spindle motor 402 to perform a single rotation or an integral multiple number of rotations. Then the mth sector is accessed again to reverse the vertical magnetization polarities (magnetization directions) of all bit patterns in the mth sector, using the magnetic field application element 303 (see FIG. 3) in the magnetic head 403 (S505). For the polarities, it is desirable that, for example, as shown in FIG. 1, the polarity magnetized in a front-side direction of the BPR-ROM medium 401 be Polarity 0 and the polarity magnetized in a back-side direction be Polarity 1. It is also desirable for the entire medium be magnetized in advance to either one of Polarity 0 and Polarity 1 as an initial state of the BPR-ROM medium 401. When the entire medium is magnetized to, for example, Polarity 0 as an initial state, at operation S505, the vertical magnetization polarities of all bit patterns in the mth sector are reversed to Polarity 1.

Subsequently, the mth sector is accessed again (S506) to measure a BER. The BER obtained after the polarity reversal is DA converted and the DA converted BER is held as BER1 in, for example, the register (not shown) included in the main controller unit 407 (S507).

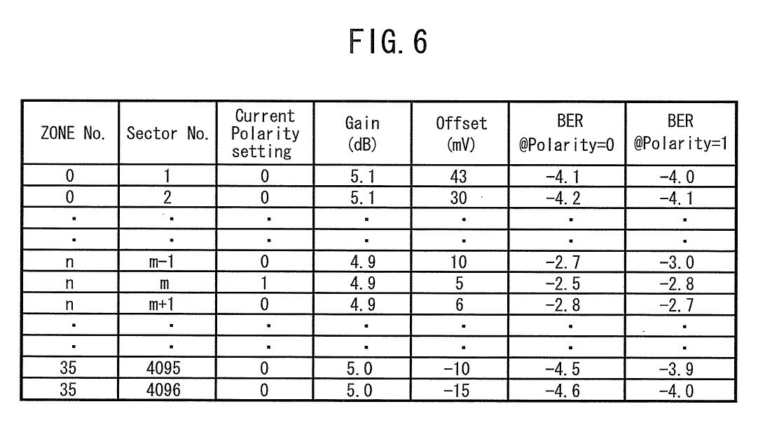

Sector management information on the mth sector obtained by the above-described process is recorded in a sector management table shown in FIG. 6, for example, that is stored in the flash memory 409, as Zone No., Sector No., a Current Polarity setting, BER0 (BER@Polarity=0), and BER1 (BER@Polarity=1).

Also, a gain (Gain (dB)) and an offset value (Offset (mV)) of the preamplifier 406 for when information in the mth sector is reproduced can be recorded as part of the sector management information, as shown in FIG. 6.

Note that although in FIG. 6 sector management information on all sectors (including also sectors where a sector error has not occurred) is recorded, the condition of obtaining sector management information may be arbitrarily set according to the application. That is, the sector management information may be recorded only for those sectors where a sector error has occurred. Note that in the operation flowchart in FIG. 5 sector management information is recorded in the flash memory 409 only for those sectors where a sector error has occurred.

Note also that sector management information does not necessarily need to be recorded and managed in the flash memory 409. Depending on the situation, an information recordable area may be provided on the BPR-ROM medium 401 and sector management information may be recorded and managed in the area.

Subsequent to the recording of sector management information in the flash memory 409, it is determined whether the BER0 value for Polarity=0 is greater than the BER1 value for Polarity=1 (S508).

If BER0>BER1, i.e., the determination at operation S508 is YES, then since the polarity state of the current Polarity=1 set at operation S505 has a lower error rate, Polarity=1 is recorded in the sector management table (the mth sector) shown in FIG. 6 included in the flash memory 409, as a Current Polarity setting which is part of the sector management information (S508->S510).

On the other hand, if BER0≦BER1, i.e., the determination at operation S508 is NO, then since the polarity state of Polarity=0 which is obtained at an initial point in time at operation S501 has a lower error rate, the main controller unit 407 waits for the spindle motor 402 to perform a single rotation or an integral multiple number of rotations. Then the mth sector is accessed again to change the vertical magnetization polarities of all bit patterns in the mth sector back to Polarity=0, using the magnetic field application element 303 (see FIG. 3) in the magnetic head 403 (S509). Then, the Polarity=0 is recorded in the sector management table (the mth sector) shown in FIG. 6 included in the flash memory 409, as a Current Polarity setting which is part of the sector management information (S509->S510)

Thereafter, the sector number m is incremented by one (S511) and a next sector is accessed (S503->S501).

As such, by changing the vertical magnetization polarity to one with better error characteristics based on the BER, the reproduction characteristics for when the same sector is reproduced next time can be improved.

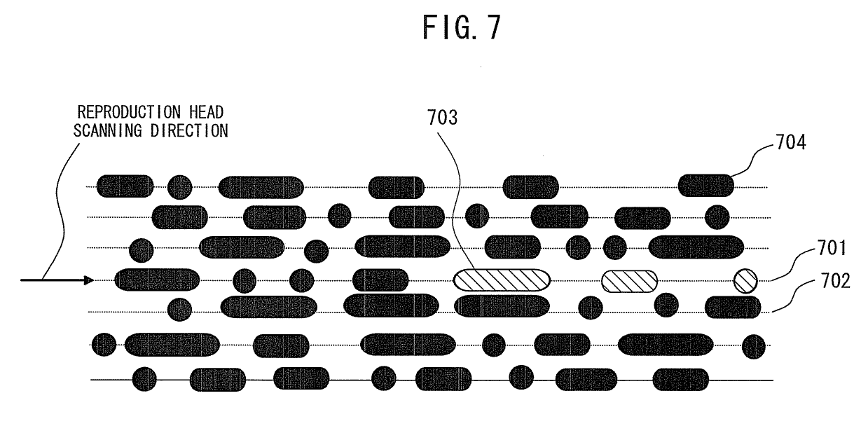

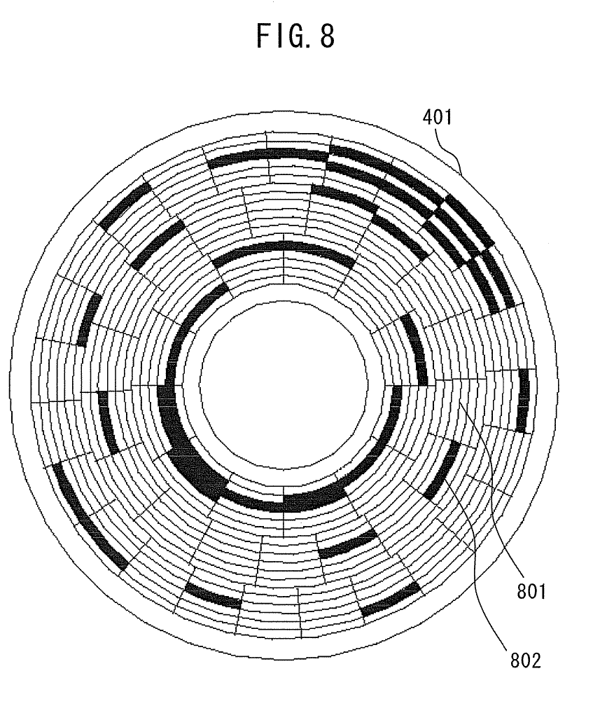

FIGS. 7 and 8 are diagrams showing exemplary polarity arrangements on the BPR-ROM medium 401.

FIG. 7 is a diagram showing that bit patterns 703 on a reproduction track 701 have better BER characteristics when being magnetized to Polarity=1, because of a large amount of offset of an adjacent track 702 to the side of the reproduction track 701 and the influence of, for example, the shapes of surrounding bit patterns with Polarity=0.

In FIG. 8, sections divided on concentric circles on the BPR-ROM medium 401 indicate sector areas and a white section 801 indicates a sector magnetized to Polarity=0 and a black section 802 indicates a sector magnetized to Polarity=1.

Reasons that the asymmetry described in the Background section is improved by the polarity being able to be changed form sector to sector in the above-described manner include the following two.

The first reason is that nonlinearity of a signal detection circuit and asymmetry caused by bit patterns may be cancelled out by polarity reversal.

The second reason is that since a magnetic field to be actually received by the reproduction element 304 (see FIG. 3) has influence of magnetic flux from surrounding bit patterns, asymmetry may be reduced by reversal of the polarity of a relevant sector.

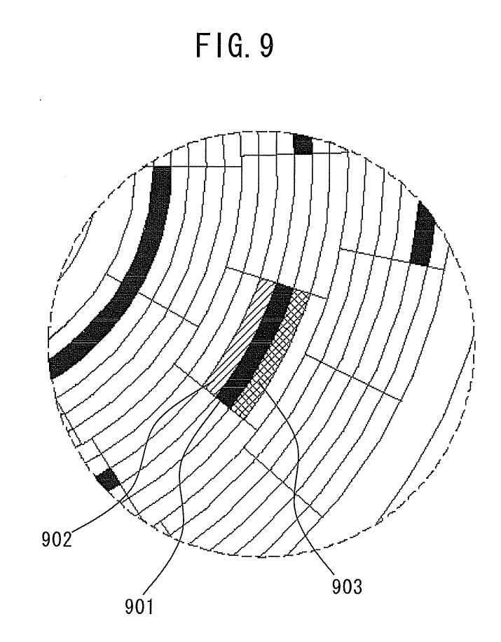

In the above-described embodiment of the present invention, as shown in FIG. 9, by further managing polarity information on a first adjacent sector 902 and a second adjacent sector 903 that are adjacent to a reproduction sector 901, a further improvement in reproduction characteristics can be achieved.

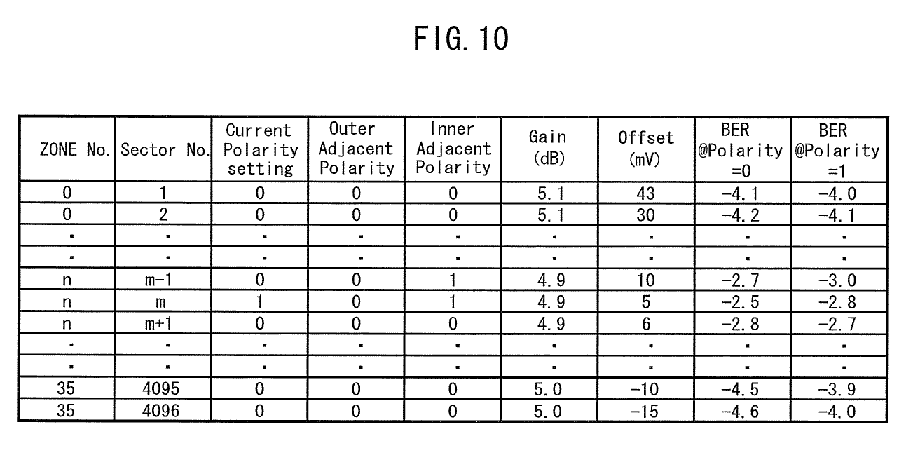

FIG. 10 is a diagram showing an example of a sector management table that is stored in the flash memory 409 in FIG. 4 and records sector management information including also the polarities of the above-described adjacent sectors. In FIG. 10, “Inner Adjacent Polarity” indicates the polarity of the first adjacent sector 902 on the inner side relative to the reproduction sector 901 in FIG. 9 and “Outer Adjacent Polarity” indicates the polarity of the second adjacent sector 903 on the outer side relative to the reproduction sector 901.

A crosstalk phenomenon that is one of the problems with a BPR-ROM medium described previously in the Background section is primarily caused by the influence from an adjacent track. Hence, while managing the sector management table shown in FIG. 10, by determining a BER for each sector while changing the polarities of adjacent tracks, reproduction characteristics may be improved.

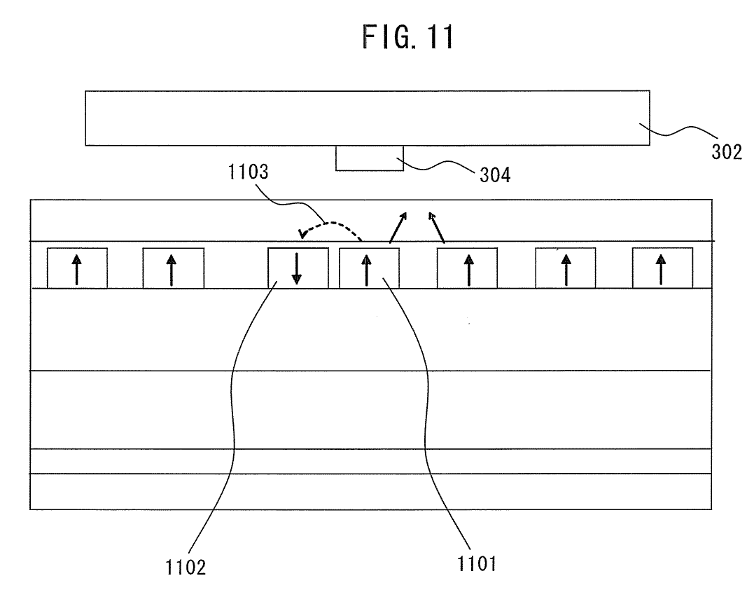

FIG. 11 is an illustrative diagram showing an influence exerted on a reproduction track by the magnetization state of an adjacent track. Due to the influence of the magnetization state of an adjacent track 1102, a magnetic flux flow 1103 occurs and accordingly the amount of magnetic flux flowing into a reproduction element 304 from a reproduction track 1101 changes. In particular, as shown in FIG. 11, when the adjacent track 1102 is formed to be offset (off-tracked) in a direction approaching the reproduction track 1101, crosstalk may be suppressed by reversing the polarity of the adjacent track 1102 relative to the reproduction track 1101.

By thus managing, as sector management information, an average magnetization state, reproduction characteristics in that state, a gain and an offset of a detection system, etc., for each sector and using the sector management information when the sector is reproduced next time, a significant improvement in reproduction characteristics can be achieved.

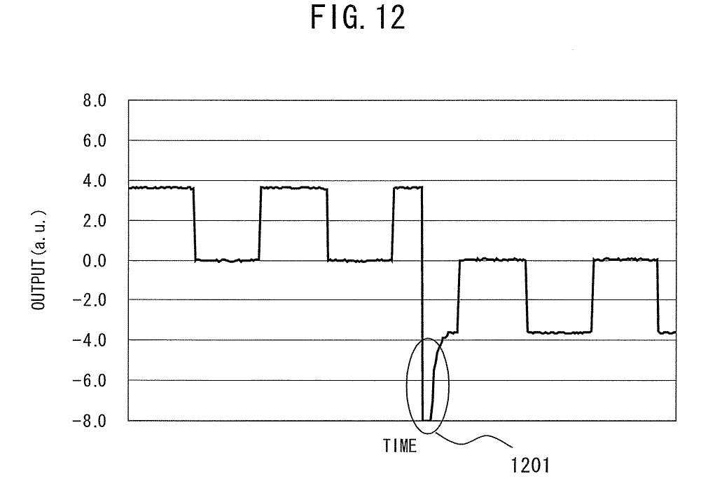

At that time, a problem may occur due to polarity reversal. Specifically, due to an abrupt change in signal output at a location where the polarity is reversed, a signal sticking phenomenon may occur in a detection circuit, as shown as 1201 in FIG. 12, for example. The sticking phenomenon is a phenomenon in which since a change in signal is abrupt, an output value momentarily exceeds a dynamic range of the detection circuit and becomes saturated and thus requires time to return to its normal output value again.

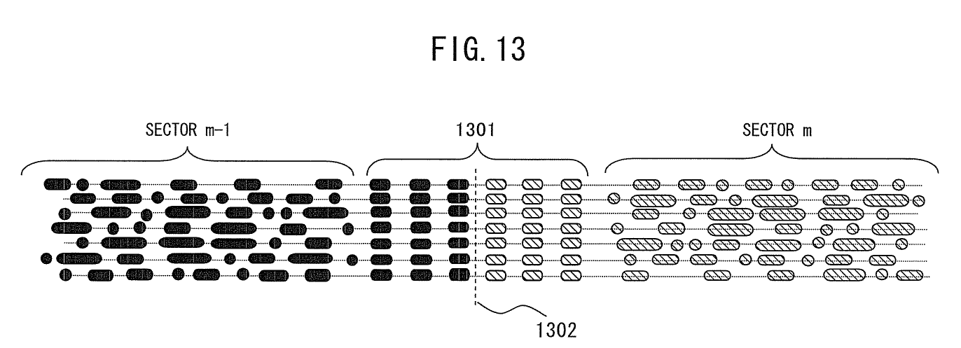

To avoid this phenomenon, in the embodiment of the present invention, as shown in FIG. 13, a buffer area 1301 is provided between sectors and polarity switching is performed substantially in a center 1302 of the buffer area 1301.

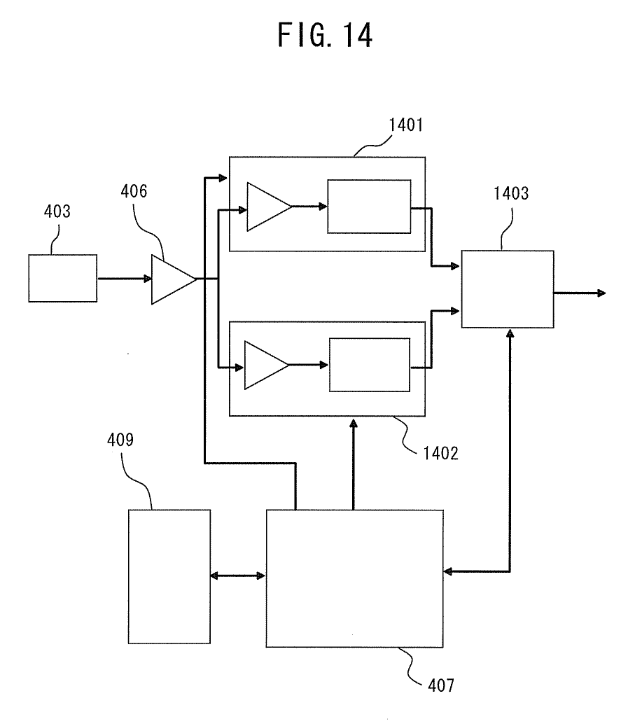

Furthermore, in the embodiment, as shown in FIG. 14, as a detection system for a signal from the magnetic head 403 and the preamplifier 406 (see FIG. 4), a first reproduction processing system 1401 and a second reproduction processing system 1402 are provided and a reproduction processing system to be used is selected according to the magnetization polarity of a sector. At that time, using sector management information stored in the flash memory 409 (see FIG. 4), the main controller unit 407 selects one of 1401 and 1402 in FIG. 14 as a reproduction processing system for a sector to be reproduced, based on the above-described operation flowchart in FIG. 5, etc. At that time, the other one of the reproduction processing systems which is not selected is allowed to hold an input signal, whereby a sticking phenomenon shown in FIG. 12 can be avoided.

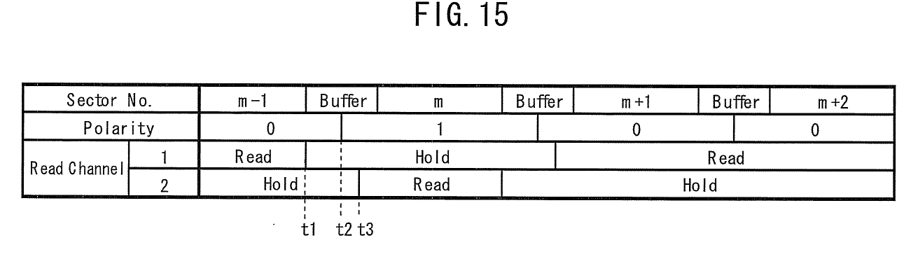

FIG. 15 is an operation timing chart schematically showing timing of selection and holding for the reproduction processing systems shown in FIG. 14. When the polarity being 0 in an m−1 th sector is reversed in an mth sector, Read Channel 1=the first reproduction processing system 1401 enters a buffer area and holds an input signal (t1), while, at a location that slightly passes over substantially the center of the buffer area (t2), Read Channel 2=the second reproduction processing system 1402 starts reproduction (t3). By this, a reproduction signal sticking phenomenon can be avoided.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of reproducing information on a bit-patterned recording medium having a recording layer in which magnetic substances are discontinuously formed, the method comprising:
managing an average magnetization state of each sector on the bit-patterned recording medium as sector management information; and
setting an information reproduction condition for the sector on the bit-patterned recording medium based on the sector management information.

2. The method according to claim 1, further comprising:
magnetizing an average magnetization direction of each sector on the bit-patterned recording medium in a first magnetization direction;
reproducing the sector and obtaining reproduction characteristics thereof as first reproduction characteristics;
magnetizing the average magnetization direction of each sector in a second magnetization direction differing by 180 degrees from the first magnetization direction;
reproducing the sector and obtaining reproduction characteristics thereof as second reproduction characteristics; and
managing the first reproduction characteristics and the second reproduction characteristics as additional sector management information.

3. The method according to claim 2, further comprising:
magnetizing the average magnetization direction of the sector in a direction corresponding to one of the first reproduction characteristics and the second reproduction characteristics of the sector that has better reproduction characteristics.

4. The method according to claim 3, further comprising:
providing a buffer area between sectors on the bit-patterned recording medium and switching the average magnetization direction between the sectors at a substantially central location of the buffer area.

5. The method according to claim 2, wherein the first reproduction characteristics and the second reproduction characteristics include an error rate value, a gain value and an offset value of a reproduction amplifier for when information on each sector on the bit-patterned recording medium is reproduced.

6. The method according to claim 2, wherein an average magnetization state of a sector that is adjacent to a sector in a direction intersecting a track on the bit-patterned recording medium is managed as average magnetization information.

7. An apparatus that reproduces information on a bit-patterned recording medium having a recording layer in which magnetic substances are discontinuously formed, the apparatus comprising:
a magnetic field applying unit that magnetizes bit patterns of each sector on the bit-patterned recording medium in a specified magnetization direction;
a reproducing unit that reproduces information on the bit patterns of each sector on the bit-patterned recording medium;
a sector management information obtaining unit that causes the magnetic field applying unit to magnetize the bit patterns of the sector in a first magnetization direction, causes the reproducing unit to reproduce the sector in a magnetization state with the first magnetization direction, and obtains reproduction characteristics thereof as first reproduction characteristics; and causes the magnetic field applying unit to magnetize the bit patterns of the sector in a second magnetization direction, causes the reproducing unit to reproduce the sector in a magnetization state with the second magnetization direction, and obtains reproduction characteristics thereof as second reproduction characteristics, the second magnetization direction differing by 180 degrees from the first magnetization direction; and
a sector management information storage unit that stores an average magnetization state, the first reproduction characteristics, and the second reproduction characteristics of each sector on the bit-patterned recording medium, as sector management information.

8. The apparatus according to claim 7, further comprising:
an average magnetization direction controlling unit that causes the magnetic field applying unit to magnetize an average magnetization direction of a sector in a direction corresponding to one of first reproduction characteristics and second reproduction characteristics of the sector that has better reproduction characteristics.
